(19) United States
(12) Patent Application Publication
(10) Pub. No.: US 2012/0158610 A1
(43) Pub. Date: Jun. 21, 2012

(54) Methods of monitoring propofol through a supply chain

(76) Inventors: Bradley Botvinick, Huntington Woods, MI (US); Shane M. Popp, Santa Monica, CA (US)

(21) Appl. No.: 13/374,117

(22) Filed: Dec. 12, 2011

Related U.S. Application Data
(60) Provisional application No. 61/459,729, filed on Dec. 17, 2010.

(51) Int. Cl. G06Q 50/28; B65D 85/00

(52) U.S. Cl. 705/341; 206/459.5

(57) ABSTRACT

Methods of monitoring Propofol through a supply chain are disclosed herein. Consequently, the methods perform authentication of propofol as it is transported through the supply chain to the end user whereby propofol manufacturers and distributors can achieve data and product integrity and ultimately minimize cost.

### CROSS-REFERENCE TO RELATED APPLICATIONS

This application claims priority to U.S. Provisional Patent Application No. 61/459,729 filed 17 Dec. 2010, the contents of which are fully incorporated by reference herein.

### STATEMENT OF RIGHTS TO INVENTIONS MADE UNDER FEDERALLY SPONSORED RESEARCH

Not applicable.

### FIELD OF THE INVENTION

The invention described herein relates to the field of process control and automated industrial manufacturing. Specifically, manufacturing execution systems and methods used for the monitoring and execution of propofol manufacture. The invention further relates to the enhancement of computer system technologies and information technology to produce higher quality more efficient propofol thereby minimizing cost.

### BACKGROUND OF THE INVENTION

Propofol (2,6-diisopropylphenol) is created by a reaction of phenol with propylene in the presence of an aluminum phenoxide. Propofol is a well-known and widely used intravenous anesthetic agent. A significant advantage of using propofol is a rapid onset following infusion or bolus injection and the benefit of a very short recovery time, which requires minutes rather than hours. Propofol's hypnotic properties permit it to be used as both a sedative and to induce and maintain general anesthesia. Propofol uses ethylenediaminetetraacetic acid (EDTA) as a preservative agent (U.S. Pat. No. 5,714,520). Additionally, several versions of propofol with modified formulations exist as well. For example, Propofol (Gensia Sicor/Baxter) uses sodium metabisulfate (U.S. Pat. No. 6,147,122). Other preservatives such as benzyl alcohol, sulfite, pentetate, and edetate are used.

The chemical properties of propofol make it susceptible to microbial growth. Thus, oil in water emulsions of propofol are used to minimize microbial activity. Additionally, the manufacture of propofol is a highly unstable complex process. In fact, in early 2010, there was a shortage of propofol in the U.S. Accordingly, the Food and Drug Administration is currently allowing preservative free propofol to be sold in the U.S. to avoid further shortages. However, currently there are no U.S. manufacturers of propofol.

Given the current deficiencies associated with propofol manufacture and the fact that the demand from a public health standpoint is ever increasing, it becomes clear that providing an integrated systems approach to propofol manufacture is desirable. Specifically, producing propofol from a “quality by design” approach (i.e. where quality is designed into the production versus testing quality post-production) is advantageous. The present invention provides this solution.

### SUMMARY OF THE INVENTION

The invention provides for manufacturing execution systems (denoted herein as manufacturing execution system or MES) and methods thereof designed for use in manufacturing propofol. Specifically, software programs that monitor quality control and the quality process used in the manufacture, processing, and storing of propofol. In certain embodiments, the software programs are used in a continuous manner to ensure purity and consistency of an ingredient used in propofol manufacture.

The invention further comprises a software program that is fully integrated and automated to monitor the entire propofol manufacturing process.

The invention further comprises integrating a manufacturing execution system into a propofol manufacturing system whereby control of the propofol manufacturing process is attained.

In certain embodiments, the MES is integrated into a chemical synthesis system used in propofol manufacturing.

In certain embodiments, the MES is integrated into a vessel system used in propofol manufacturing.

In certain embodiments, the MES is integrated into a liquid mixing system used in propofol manufacturing.

In certain embodiments, the MES is integrated into a filtration system used in propofol manufacturing.

In certain embodiments, the MES is integrated into a pH system used in propofol manufacturing.

In certain embodiments, the MES is integrated into a standardization system used in propofol manufacturing.

In certain embodiments, the MES is integrated into a pure water system used in propofol manufacturing.

In certain embodiments, the MES is integrated into a homogenization system used in propofol manufacturing.

In certain embodiments, the MES is integrated into a sterilization system used in propofol manufacturing.

In certain embodiments, the MES is integrated into a water for injection (WFI) used in propofol manufacturing.

In certain embodiments, the MES is integrated into a modular cleanroom system used in propofol manufacturing.

In certain embodiments, the MES is integrated into a packaging system used in propofol manufacturing.

In certain embodiments, the IVIES is integrated into a vial inspection system used in propofol manufacturing.

In certain embodiments, the MES is integrated into a serialization (e-pedigree) system used in propofol manufacturing.

In certain embodiments, the manufacturing execution system comprises a software program with a computer memory having computer readable instructions adapted for use in propofol manufacturing.

In certain embodiments, the manufacturing execution system continuously monitors the propofol manufacturing process.

In certain embodiments, the manufacturing execution system semi-continuously monitors the propofol manufacturing process.

Based on the foregoing non-limiting exemplary embodiments, the software program can be interfaced with hardware systems or software systems or devices to monitor quality assurance protocols put in place by the quality control unit.

The invention further comprises a manufacturing execution system which integrates application software and methods disclosed herein to provide a comprehensive validation and quality assurance protocol that is used by a plurality of end users whereby the data compiled from the system is analyzed and used to determine if quality assurance protocols and validation protocols are being achieved.

The invention further comprises implementing the manufacturing execution systems and software program to multiple propofol product lines whereby simultaneous propofol production lines are monitored using the same system.

The invention further comprises implementation of the manufacturing execution system and software program described herein into the chemical synthesis, vessel, liquid mixing, filtration, pH, standardization, pure water, standardization, homogenization, sterilization, WFI, modular cleanroom, packaging, vial inspection, and serialization (e-pedigree) system(s) subset of the propofol manufacturing process whereby the data compiled by the subset processes is tracked continuously overtime and said data is used to analyze the subset processes and whereby said data is integrated and used to analyze the quality control process of the propofol manufacturing process at-large.

The invention further comprises a manufacturing execution system, which monitors specific batches of propofol and tracks the batches using lot numbers, batch numbers, and control numbers.

The invention further comprises a manufacturing execution system, which controls the propofol manufacturing process, increases productivity, and improves quality of propofol over time.

### BRIEF DESCRIPTION OF THE FIGURES

FIG. 1. General Schematic of a Propofol Manufacturing Process. As shown in the figure, the first step is chemical synthesis followed by liquid mixing. The third step is filtration followed by homogenization followed by standardization followed by packaging followed by sterilization. Finally, the propofol vials are inspected via a vial inspection system and then the propofol dosage form is serialized.

FIG. 2. Schematic of a Manufacturing execution system integrated into a Propofol Chemical Synthesis Process. As shown in the figure, the entire propofol chemical synthesis system is integrated into a manufacturing execution system. Data is monitored at critical control points to ensure quality parameters are being achieved. The data is monitored and analyzed on a continuous basis.

FIG. 3. Schematic of a Manufacturing execution system integrated into a propofol Sterile Filtration system used in propofol manufacture. As shown in the Figure, the entire sterile filtration system is integrated into the Manufacturing execution system. Data is monitored at critical control points to ensure quality parameters are being achieved based on predetermined sterility assurance level (SAL). The data is monitored and analyzed on a continuous basis.

FIG. 4. Schematic of a Manufacturing execution system integrated into a propofol liquid mixing system used in propofol manufacture. As shown in the figure, the entire propofol liquid mixing system is integrated into the Manufacturing execution system. Data is monitored at critical control points to ensure quality parameters are being achieved. The data is monitored and analyzed on a continuous basis.

FIG. 5. Schematic of a Manufacturing execution system integrated into a propofol homogenization system used in propofol manufacture. As shown in the figure, the entire propofol homogenization system is integrated into the Manufacturing execution system. Data is monitored at critical control points to ensure quality parameters are being achieved. The data is monitored and analyzed on a continuous basis.

FIG. 6. Schematic of a Manufacturing execution system integrated into a propofol standardization system used in propofol manufacture. As shown in the figure, the entire propofol standardization system is integrated into the Manufacturing execution system. Data is monitored at critical control points to ensure quality parameters are being achieved. The data is monitored and analyzed on a continuous basis.

FIG. 7. Schematic of a Manufacturing execution system integrated into a propofol packaging system used in propofol manufacture. As shown in the figure, the entire propofol packaging system is integrated into the Manufacturing execution system. Data is monitored at critical control points to ensure quality parameters are being achieved. The data is monitored and analyzed on a continuous basis.

FIG. 8. Schematic of a Manufacturing execution system integrated into a propofol sterilization system used in propofol manufacture. As shown in the figure, the entire propofol sterilization system is integrated into the Manufacturing execution system. Data is monitored at critical control points to ensure quality parameters are being achieved based on predetermined sterility assurance level (SAL). The data is monitored and analyzed on a continuous basis. After sterilization, the propofol product is serialized and destined to shipping.

FIG. 9. Schematic of Supply Chain Distribution of Propofol. Once final propofol product is determined the propofol product is packaged using the packaging system of the invention. The propofol dosage forms travel from packaging to distribution to wholesale to doctors or retail or hospitals and then to the end-user. Note, the supply chain can include several different configurations.

### DETAILED DESCRIPTION OF THE INVENTION

Outline of Sections

I.) Definitions

II.) Software Program and Computer Product

III.) Analysis

IV.) Manufacturing execution system(s)

V.) KITS/Articles of Manufacture

VI.) Sensors

VII.) Supply Chain Management

VIII.) Background to Propofol Manufacturing

I.) Definitions:

Unless otherwise defined, all terms of art, notations and other scientific terms or terminology used herein are intended to have the meanings commonly understood by those of skill in the art to which this invention pertains unless the context clearly indicates otherwise. In some cases, terms with commonly understood meanings are defined herein for clarity and/or for ready reference, and the inclusion of such definitions herein should not necessarily be construed to represent a substantial difference over what is generally understood in the art. Many of the techniques and procedures described or referenced herein are well understood and commonly employed using conventional methodology by those skilled in the art, such as, for example, the widely utilized current Good Manufacturing Practice guidelines.

“interface” means the communication boundary between two or more entities, such as a piece of software, a hardware device, or a user. It generally refers to an abstraction that an entity provides of itself to the outside. This separates the methods of external communication from internal operation, and allows it to be internally modified without affecting the way outside entities interact with it, as well as provide multiple abstractions of itself. It may also provide a means of translation between entities, which do not speak the same language, such as between a human and a computer. The interface between a human and a computer is called a user interface. Interfaces between hardware components are physical interfaces. Interfaces between software exist between separate software components and provide a programmatic mechanism by which these components can communicate.

“abstraction” means the separation of the logical properties of data or function from its implementation in a computer program.

“algorithm” means any sequence of operations for performing a specific task.

“analog” means pertaining to data [signals] in the form of continuously variable [wave form] physical quantities; e.g., pressure, resistance, rotation, temperature, voltage.

“analog device” means a device that operates with variables represented by continuously measured quantities such as pressures, resistances, rotations, temperatures, and voltages.

“analog-to-digital converter” means input related devices, which translate an input device's [sensor] analog signals to the corresponding digital signals needed by the computer.

“analysis” means a course of reasoning showing that a certain result is a consequence of assumed premises. “application software” means software designed to fill specific needs of a user.

“bar code” means a code representing characters by sets of parallel bars of varying thickness and separation that are read optically by transverse scanning.

“basic input/output system” means firmware that activates peripheral devices in a PC. Includes routines for the keyboard, screen, disk, parallel port and serial port, and for internal services such as time and date. It accepts requests from the device drivers in the operating system as well from application programs. It also contains autostart functions that test the system on startup and prepare the computer for operation. It loads the operating system and passes control to it.

“benchmark” means a standard against which measurements or comparisons can be made.

“block check” means the part of the error control procedure that is used for determining that a block of data is structured according to given rules.

“bootstrap” means a short computer program that is permanently resident or easily loaded into a computer and whose execution brings a larger program, such an operating system or its loader, into memory.

“boundary value” means a data value that corresponds to a minimum or maximum input, internal, or output value specified for a system or component.

“boundary value analysis” means a selection technique in which test data are chosen to lie along “boundaries” of the input domain [or output range] classes, data structures, procedure parameters, etc.

“branch analysis” means a test case identification technique that produces enough test cases such that each decision has a true and a false outcome at least once.

“calibration” means ensuring continuous adequate performance of sensing, measurement, and actuating equipment with regard to specified accuracy and precision requirements.

“configurable, off-the-shelf software” means application software, sometimes general purpose, written for a variety of industries or users in a manner that permits users to modify the program to meet their individual needs.

“control flow analysis” means a software V&V task to ensure that the proposed control flow is free of problems, such as design or code elements that are unreachable or incorrect.

“controller” means hardware that controls peripheral devices such as a disk or display screen. It performs the physical data transfers between main memory and the peripheral device.

“corrective maintenance” means maintenance performed to correct faults in hardware or software.

“critical control point” means a function or an area in a manufacturing process or procedure, the failure of which, or loss of control over, may have an adverse affect on the quality of the finished product and may result in an unacceptable health risk.

“data integrity” means the degree to which a collection of data is complete, consistent, and accurate.

“design level” means the design decomposition of the software item; e.g., system, subsystem, program or module.

“diagnostic” means pertaining to the detection and isolation of faults or failures.

“end user” means a person, device, program, or computer system that uses an information system for the purpose of data processing in information exchange.

“failure analysis” means determining the exact nature and location of a program error in order to fix the error, to identify and fix other similar errors, and to initiate corrective action to prevent future occurrences of this type of error.

“Failure Modes and Effects Analysis” means a method of reliability analysis intended to identify failures, at the basic component level, which have significant consequences affecting the system performance in the application considered.

“logic analysis” means evaluates the safety-critical equations, algorithms, and control logic of the software design.

“low-level language” means the advantage of assembly language is that it provides bit-level control of the processor allowing tuning of the program for optimal speed and performance. For time critical operations, assembly language may be necessary in order to generate code, which executes fast enough for the required operations.

“maintenance” means activities such as adjusting, cleaning, modifying, overhauling equipment to assure performance in accordance with requirements.

“path analysis” means analysis of a computer program to identify all possible paths through the program, to detect incomplete paths, or to discover portions of the program that are not on any path.

“quality assurance” means the planned systematic activities necessary to ensure that a component, module, or system conforms to established technical requirements.

“quality control” means the operational techniques and procedures used to achieve quality requirements.

“software engineering” means the application of a systematic, disciplined, quantifiable approach to the development, operation, and maintenance of software.

“software engineering environment” means the hardware, software, and firmware used to perform a software engineering effort.

“system administrator” means the person that is charged with the overall administration, and operation of a computer system. The System Administrator is normally an employee or a member of the establishment.

“system analysis” means a systematic investigation of a real or planned system to determine the functions of the system and how they relate to each other and to any other system.

“system design” means a process of defining the hardware and software architecture, components, modules, interfaces, and data for a system to satisfy specified requirements.

“top-down design” means pertaining to design methodology that starts with the highest level of abstraction and proceeds through progressively lower levels.

“validation” means establishing documented evidence, which provides a high degree of assurance that a specific process will consistently produce a product meeting its predetermined specifications and quality attributes.

“validation, process” means establishing documented evidence which provides a high degree of assurance that a specific process will consistently produce a product meeting its predetermined specifications and quality characteristics.

“validation, prospective” means validation conducted prior to the distribution of either a new product, or product made under a revised manufacturing process, where the revisions may affect the product's characteristics.

“validation protocol” means a written plan stating how validation will be conducted, including test parameters, product characteristics, production equipment, and decision points on what constitutes acceptable test results.

“validation, retrospective” means validation of a process for a product already in distribution based upon accumulated production, testing and control data. Retrospective validation can also be useful to augment initial premarket prospective validation for new products or changed processes. Test data is useful only if the methods and results are adequately specific. Whenever test data are used to demonstrate conformance to specifications, it is important that the test methodology be qualified to assure that the test results are objective and accurate.

“structured query language” means a language used to interrogate and process data in a relational database. Originally developed for IBM mainframes, there have been many implementations created for mini and micro computer database applications. SQL commands can be used to interactively work with a data base or can be embedded with a programming language to interface with a database.

“Batch” means a specific quantity of propofol that is intended to have uniform character and quality, within specified limits, and is produced according to a single manufacturing order during the same cycle of manufacture.

“Component” means any ingredient intended for use in the manufacture of propofol, including those that may not appear in such propofol product.

“Propofol product” means a finished dosage form, for example, emulsion, vial, injectible, solution, powder etc. that contains an active propofol ingredient generally, but not necessarily, in association with inactive ingredients.

“Active propofol ingredient” means any component that is derived from the chemical synthesis of phenol and propylene in the presence of aluminum phenoxide and is intended to furnish pharmacological activity or to induce anesthesia in mammals.

“Inactive ingredient” (a.k.a. excipient) means a substance used as a carrier for the active ingredients of a propofol product. In addition, excipients can be used to aid the process by which propofol is manufactured. The active propofol ingredient is then dissolved or mixed with an excipient. Excipients are also sometimes used to bulk up formulations with active propofol ingredients, to allow for convenient and accurate dosage. Examples of excipients, include but are not limited to, thickeners, binders, starches, gums, dilutents, flavors, colors, emulsifiers, and preservatives.

“In-process material” means any material fabricated, compounded, blended, or derived by chemical reaction that is produced for, and used in, the preparation of the propofol product.

“Lot number, control number, or batch number” means any distinctive combination of letters, numbers, or symbols, or any combination thereof, from which the complete history of the manufacture, processing, packing, holding, and distribution of a batch or lot of propofol product or active propofol ingredient or other material can be determined.

“Quality control unit” means any person or organizational element designated by the firm to be responsible for the duties relating to quality control.

“Acceptance criteria” means the product specifications and acceptance/rejection criteria, such as acceptable quality level and unacceptable quality level, with an associated sampling plan, that are necessary for making a decision to accept or reject a lot or batch.

“manufacturing execution system” (MES) means an integrated hardware and software solution designed to measure and control activities in the production areas of propofol manufacturing organizations to increase productivity and improve quality. For the purposes of this definition, a MES relates only to the propofol manufacturing processes and systems. The use of a MES of the present invention not relating to the manufacturing, storing, or production of propofol is specifically excluded from the definition of an MES.

“Process analytical technology” (a.k.a. PAT) means a mechanism to design, analyze, and control propofol manufacturing processes through the measurement of critical process parameters and quality attributes.

“Homogenization” means means a term connoting a process that makes a mixture the same throughout the entire substance (i.e. homogeneous). Note, for the purposes of this definition, when soft solids are milled in a liquid, this can be seen as a form of homogenization.

“Sterilization” means any process that effectively kills or eliminates transmissible agents (such as fungi, bacteria, viruses, prions, and spore forms, etc.) from a surface, equipment, foods, medications, propofol, or biological culture medium. Sterilization can be achieved through application of heat, chemicals, irradiation, high pressure or filtration.

“Emulsion” means a mixture of two or more immiscible (unblendable) liquids. Emulsions are part of a more general class of two-phase systems of matter called colloids.

“Emulsifier” means a substance which stabilizes an emulsion by increasing its kinetic stability. One class of emulsifiers is known as surface-active substances, or surfactants.

“Serialization” means a comprehensive system to track and trace the passage of drugs through the entire supply chain. Examples of information used to achieve drug product serialization include but are not limited to, the name of the drug, its quantity, dosage form, and strength, lot number, batch number, and control number, expiration date, recall information, and detailed supply chain ownership information.

“e-pedigree” means an electronic document which satisfies the serialization requirement(s).

“Bulk propofol” (a.k.a. propofol drug substance) means the propofol or the propofol drug product which has not been filled into final containers for distribution. Final formulated bulk propofol generally refers to propofol drug product which is formulated and being stored or held prior to filling. Propofol drug substance may be stored or held as “bulk” or “concentrated bulk” prior to formulation into propofol drug product.

II.) Software Program

The invention provides for a software program that is programmed in a high-level or low-level programming language, preferably a relational language such as structured query language, which allows the program to interface with an already existing program or a database. Other programming languages include but are not limited to C, C++, COBOL, FORTRAN, Java, Perl, Python, Smalltalk, Dataflex, PowerBuilder, FOCUS, LINC, Oracle Reports, Quest, Ab Initio, LANSA, PL/SQL, RAMIS, S, SAS, SPSS, APE, Genexus, UNIFACE, CSS, ColdFusion, and MS visual basic.

In addition, the invention provides for a fifth-generation programming language (“5GL”) based around solving problems using constraints given to the program, rather than using an algorithm written by a computer programmer. Essentially, a 5GL of the present invention is designed to make the computer solve the problem (i.e. higher quality more efficient, consistent propofol production). This way, a programmer only needs to worry about what problems need to be solved and what conditions need to be met, without worrying about how to implement a routine or algorithm to solve them. In one embodiment, a 5GL of the present invention uses Prolog, OPS5, or Mercury programming language.

It will be readily apparent to one of skill in the art that the preferred embodiment will be a software program that can be easily modified to conform to numerous software-engineering environments. One of ordinary skill in the art will understand and will be enabled to utilize the advantages of the invention by designing the system with top-down design. The level of abstraction necessary to achieve the desired result will be a direct function of the level of complexity of the process that is being monitored.

The invention further comprises computer software which comprises three (3) layers. It will be appreciated by one of ordinary skill in the art that the three (3) layers may overlap and may or may not be distinct layers. The invention comprises a system software layer, which helps run the computer system. The system software layer of the invention comprises, operating systems, device drivers, diagnostic tools, servers, windowing systems, and other utilities. The purpose of systems software is to insulate the applications programmer as much as possible from the details of the particular computer complex being used, especially memory and other hardware features, and such as accessory devices as communications, printers, readers, displays, keyboards, etc.

The invention comprises computer software containing a programming software layer, which provides tools to assist a programmer to use programming languages in a more convenient way. These tools include but are note limited to, text editors, compilers, interpreters, linkers, debuggers, and so forth. An Integrated development environment (IDE) merges those tools into a software bundle, and a programmer may not need to type multiple commands for compiling, interpreting, debugging, tracing, and etc., especially if the IDE has an advanced graphical user interface.

The invention comprises computer software containing an application software layer which allows end users to accomplish one or more specific (non-computer related) tasks.

In one embodiment, the invention comprises an embedded system designed to perform one or a few dedicated functions, often with real-time computing constraints. It is usually embedded as part of a complete device including hardware and mechanical parts. In a preferred embodiment, the embedded system of the invention is embedded in propofol manufacturing hardware systems and mechanical parts.

One of ordinary skill will appreciate that to maximize results the ability to amend the algorithm needed to conform to the validation and QA standards set forth by the quality control unit on each step during propofol manufacture will be preferred. This differential approach to programming will provide the greatest level of data analysis leading to the highest standard of data integrity.

The preferred embodiments may be implemented as a method, system, or program using standard software programming and/or engineering techniques to produce software, firmware, hardware, or any combination thereof. The term “computer product” as used herein is intended to encompass one or more computer programs and data files accessible from one or more computer-readable devices, firmware, programmable logic, memory devices (e.g. EEPROM's, ROM's, PROM's, RAM's, SRAM's, etc.) hardware, electronic devices, a readable storage diskette, CD-ROM, a file server providing access to programs via a network transmission line, wireless transmission media, signals propagating through space, radio waves, infrared signals, etc.

The invention further provides articles (e.g., computer products) comprising a machine-readable medium including machine-executable instructions, computer systems and computer implemented methods to practice the methods of the invention. Accordingly, the invention provides computers, computer systems, computer readable mediums, computer programs products and the like having recorded or stored thereon machine-executable instructions to practice the methods of the invention. As used herein, the words “recorded” and “stored” refer to a process for storing information on a computer medium. A skilled artisan can readily adopt any known methods for recording information on a computer to practice the methods of the invention.

The computer processor used to practice the methods of the invention can be a conventional general-purpose digital computer, e.g., a personal workstation computer, including conventional elements such as microprocessor and data transfer bus.

Preferably, the program will be initiated in parallel with the propofol manufacturing process or quality assurance (“QA”) protocol. This will allow the ability to monitor the propofol manufacturing and QA process from its inception. However, in some instances the program can be bootstrapped into an already existing program that will allow monitoring from the time of execution (i.e. bootstrapped to configurable off-the-shelf software).

For example, the critical control point for monitoring an active propofol ingredient versus an inactive ingredient may not be equivalent. Similarly, the critical control point for monitoring an in-process material may vary from component to component and often from batch to batch.

In one embodiment, the invention provides for methods of interfacing a software program with a propofol manufacturing system whereby the software program is integrated into the propofol manufacturing process and control of the propofol manufacturing process is attained. The integration can be used for routine monitoring, quality control, maintenance, hazard mitigation, validation, etc.

The invention further comprises implementing the software program to multiple devices used in propofol manufacture to create a manufacturing execution system used to monitor and control the entire propofol manufacturing process.

The invention further comprises implementing the manufacturing execution system into multiple propofol product lines whereby simultaneous propofol production lines are monitored using the same system.

The invention further comprises implementation of the manufacturing execution system and software program described herein into the subset of the propofol manufacturing process whereby the data compiled by the chemical synthesis, liquid mixing, sterilization, filtration, homogenization, standardization, packaging, vial inspection, and serialization subset processes is tracked continuously overtime and said data is used to analyze the subset processes and whereby said data is integrated and used to analyze the quality control process of the propofol manufacturing process at-large.

It will also be appreciated by those skilled in the art that the various steps herein for propofol production are not required to be all performed or exist in the same production series. Thus, while in some embodiments, all steps and/or software programs and/or manufacturing execution systems described or mentioned herein are performed or exist, in other embodiments, one or more steps are optionally performed, e.g., omitted, changed (in scope, order, placement, etc.) or the like. Accordingly, those of skill in the art will recognize that many modifications may be made without departing from the scope of the present invention.

III.) Analysis

The invention provides for a method of analyzing data that is compiled as a result of the manufacturing of propofol. Further the invention provides for the analysis of data that is compiled as a result of a QA program used to monitor the manufacture of propofol in order to maintain the highest level of data integrity. In one embodiment, the parameters of the data will be defined by the quality control unit. Generally, the quality control unit will provide endpoints that need to be achieved to conform to cGMP regulations or in some instances an internal endpoint that is more restrictive to the minimum levels that need to be achieved.

The invention provides for data analysis using boundary value analysis. The boundary value will be set forth by the quality control unit. Using the boundary values set forth for a particular phase of propofol manufacture the algorithm is defined. Once the algorithm is defined, an algorithm analysis (i.e. logic analysis) takes place. One of skill in the art will appreciate that a wide variety of tools are used to confirm algorithm analysis such as an accuracy study processor.

One of ordinary skill will appreciate that different types of data will require different types of analysis. In a further embodiment, the program provides a method of analyzing block data via a block check. If the block check renders an affirmative analysis, the benchmark has been met and the analysis continues to the next component. If the block check renders a negative, the data is flagged via standard recognition files known in the art and a hazard analysis and hazard mitigation occurs.

In a further embodiment, the invention provides for data analysis using branch analysis. The test cases will be set forth by the quality control unit.

In a further embodiment, the invention provides for data analysis using control flow analysis. The control flow analysis will calibrate the design level set forth by the quality control unit, which is generated in the design phase.

In a further embodiment, the invention provides for data analysis using failure analysis. The failure analysis is initiated using the failure benchmark set forth by the quality control unit and then using standard techniques to come to error detection. The preferred technique will be top-down. For example, error guessing based on quality control group parameters, which are confirmed by error seeding.

In a further embodiment, the invention provides for data analysis using path analysis. The path analysis will be initiated after the design phase and will be used to confirm the design level. On of ordinary skill in the art will appreciate that the path analysis will be a dynamic analysis depending on the complexity of the program modification. For example, the path analysis on the output of a propofol product will be inherently more complex that the path analysis for the validation of an in-process material. However, one of ordinary skill will understand that the analysis is the same, but the parameters set forth by the quality control unit will differ.

In a further embodiment, the invention provides for data analysis using failure modes and effects analysis. The analysis of actual or potential failure modes within a propofol manufacturing system on a component-by-component and process by process level is analyzed for classification or determination of a failure upon the propofol manufacturing system. Failures which cause any error or defects in a propofol process, design, manufacture, or product are analyzed and corrective action is taken during propofol manufacture. The corrective action of the invention comprises modifying or stopping propofol manufacture to obviate a failure.

In a further embodiment, the invention provides for data analysis using root cause analysis. The analysis occurs by identifying a root cause of a failure or hazard with the intention of eliminating the root cause thereby reducing its frequency on future propofol batches.

In a preferred embodiment, the invention provides for data analysis using hazard analysis and critical control points. The analysis occurs in a systematic preventive approach to propofol manufacturing that addresses physical, chemical, and biological hazards of propofol as a means of prevention rather than finished propofol product inspection. The analysis is used in propofol manufacture to identify hazards, so that key actions and locations within a propofol manufacturing process, known as critical control points can be taken to reduce or eliminate the risk of the hazards being realized. The analysis is used at all stages of propofol production including chemical synthesis, liquid mixing, sterilization, filtration, homogenization, standardization, packaging, vial inspection, and serialization. Failures which cause any error or defects in a propofol process, design, manufacture, or product are analyzed and corrective action is taken during propofol manufacture. The corrective action of the invention comprises modifying or stopping propofol manufacture to obviate a failure.

The invention provides for a top-down design to software analysis. This preferred embodiment is advantageous because the parameters of analysis will be fixed for any given process and will be set forth by the quality control unit. Thus, performing software safety code analysis then software safety design analysis, then software safety requirements analysis, and then software safety test analysis will be preferred.

The aforementioned analysis methods are used for several non-limiting embodiments, including but not limited to, validating QA software, validating propofol manufacturing processes and systems (including hardware devices used in propofol manufacture), and validating process designs wherein the integration of the system design will allow for more efficient determination of acceptance criteria in a batch, in-process material, batch number, control number, and lot number and allow for increased access time thus achieving a more efficient cost-saving propofol manufacturing process.

IV. Manufacturing Execution System(s)

In one embodiment, the software program or computer product, as the case may be, is integrated into a manufacturing execution system that controls the propofol manufacturing process. The tools of the manufacturing execution system of the invention focus on less variance, higher volumes, tighter control, and logistics (including supply chain) of propofol manufacturing and distribution. One of ordinary skill in the art will understand that a MES of the invention possesses attributes to increase tracking, traceability, productivity, and quality of a propofol product. One of ordinary skill in the art will understand that the aforementioned attributes are achieved by monitoring such propofol manufacturing functions including, for example, equipment tracking, product genealogy, raw material tracking, production process monitoring, labor and item tracking, costing, electronic signature capture, defect and resolution monitoring, vial inspection, product serialization, executive dashboards, and other various reporting functions commensurate with propofol manufacturing.

It will be understood by one of skill in the art that the software programs or computer products integrates the hardware via generally understood devices in the art (i.e. attached to the analog device via an analog to digital converter).

The software program or computer product is integrated into the manufacturing execution system on a device-by-device basis. As previously set forth, the acceptance criteria of all devices used in propofol manufacture for the purposes of the manufacturing execution system are determined by the quality control unit. The analysis of the propofol manufacturing occurs using any of the methods disclosed herein. (See, section III entitled “Analysis”). The program monitors and processes the data and stores the data using standard methods. The data is provided to an end user or a plurality of end users for assessing the quality of data generated by the device or devices. Furthermore, the data is stored for comparative analysis to previous batches to provide a risk-based assessment in case of failure. Using the historical analysis will provide a more streamlined propofol manufacturing process and will monitor to ensure that product quality is maximized. Utilizing the historical record will provide propofol manufacturers an “intelligent” perspective to manufacturing. Over time, the manufacturing execution system will teach itself and modify the propofol manufacturing process in a way to obviate previous failures while at the same time continuously monitoring for new or potential failures. In addition, the invention comprises monitoring the data from initial process, monitoring the data at the end process, and monitoring the data from a routine maintenance schedule to ensure the system maintain data integrity and validation standards predetermined by the quality control unit.

V.) Kits/Articles of Manufacture

For use in basic input/output systems, hardware calibrations, software calibrations, computer systems audits, computer system security certification, data validation, different software system analysis, drug product serialization, quality control, and the manufacturing of propofol products described herein, kits are within the scope of the invention. Such kits can comprise a carrier, package, or container that is compartmentalized to receive one or more containers such as boxes, shrink wrap, and the like, each of the container(s) comprising one of the separate elements to be used in the method, along with a program or insert comprising instructions for use, such as a use described herein.

The kit of the invention will typically comprise the container described above and one or more other containers associated therewith that comprise materials desirable from a commercial and user standpoint, programs listing contents and/or instructions for use, and package inserts with instructions for use.

A program can be present on or with the container. Directions and or other information can also be included on an insert(s) or program(s) which is included with or on the kit. The program can be on or associated with the container.

The terms “kit” and “article of manufacture” can be used as synonyms.

The article of manufacture typically comprises at least one container and at least one program. The containers can be formed from a variety of materials such as glass, metal or plastic.

Additionally, kits comprising propofol which are serialized and contain manufacturing attributes are within the scope of the invention. Generally, the kit comprises a label containing the batch number, lot number, and/or control number of the propofol contained therein. Additionally, the label may comprise other relevant information relating to the origin, supply chain information, and expiration date of the propofol contained therein.

In a further embodiment, the label may contain readable information which can be accessed through a variety of means known in the art. In one embodiment, the label comprises RFID technology, barcodes, time stamped audit trails, electronic signatures, and global positioning systems (GPS) technology.

VI.) Sensors

In one embodiment, the invention relates to sensors that are integrated into the manufacturing execution system. It will be appreciated by one of skill in the art that the type of sensor needed will be a direct function to the type of propofol manufacturing process or system that is being monitored. For example, monitoring the chemical properties of components used during chemical synthesis of propofol will require different montoring parameters than monitoring the pH or tempurature during the liquid mixing phase of propofol manufacturing which in turn will require different monitoring parameters than monitoring the sterility assurance level (SAL) of the propofol during the sterilization process. In these situations, it will be appreciated by one of ordinary skill that either (i) the same sensors can be used with different detecting criteria or (ii) different types of sensors can be used to achieve the best level of monitoring for a specific parameter that is being monitored. Accordingly, sensors of the present invention comprise thermal, electromagnetic, mechanical, chemical, optical, radiation, acoustic, and biological sensors. In one embodiment, thermal sensors include but are not limited to thermometers, thermocouples, temperature sensitive resistors, bolometers, and calorimeters. In a further embodiment, electromagnetic sensors include but are not limited to ohmmeters, multimeters, galvanometers, ammeters, leaf electroscopes, watt-hour meters, magnetic compasses, fluxgate compasses, magnetometers, and metal detectors. In a further embodiment, mechanical sensors include but are not limited to barometers, barographs, pressure gauges, air speed indicators, rate of change sensors, flow sensors, anemometers, flow meters, gas meters, water meters, mass flow sensors, acceleration sensors, whisker sensors, Quadrature wheels, and positions switches. In a further embodiment, chemical sensors include but are not limited to oxygen sensors (a.k.a. □ sensors), ion-selective electrodes, pH glass electrodes, and redox electrodes. In a further embodiment, optical and radiation sensors include but are not limited to RADAR, LIDAR, dosimeters, particle detectors, scintillators, wire chambers, cloud chambers, bubble chambers, infrared sensors, photocells, photodiodes, phototransistors, image sensors; vacuum tube devices, and proximity sensors. In a further embodiment, acoustic sensors include but are not limited to ultrasounds and SONAR. In a further embodiment, biological sensors include but are not limited to biosensors that can detect physical aspects of the external environment such as light, motion, temperature, magnetic fields, gravity, humidity, vibration, pressure, electrical fields, and sound. Additionally, biosensors that can detect environmental molecules such as toxins, nutrients, and pheromones are within the scope of the invention. Additionally, biosensors that can detect metabolic parameters such as glucose level and oxygen level are within the scope of the invention. In a preferred embodiment, the sensor is connected to the hardware device used in propofol manufacturing (i.e. liquid mixer, sterilizer, etc.) using standard means (e.g. an analog to digital converted) which is then connected to the manufacturing execution system via a computer product which allows the computer executable instructions of the MES to interface with the sensor. The data compiled during the course of the propofol manufacturing process is then stored using methods known in the art (e.g. stored in a relational database). In a preferred embodiment, the interface is wireless and uses a LAN or the Internet.

VII.) Supply Chain Management

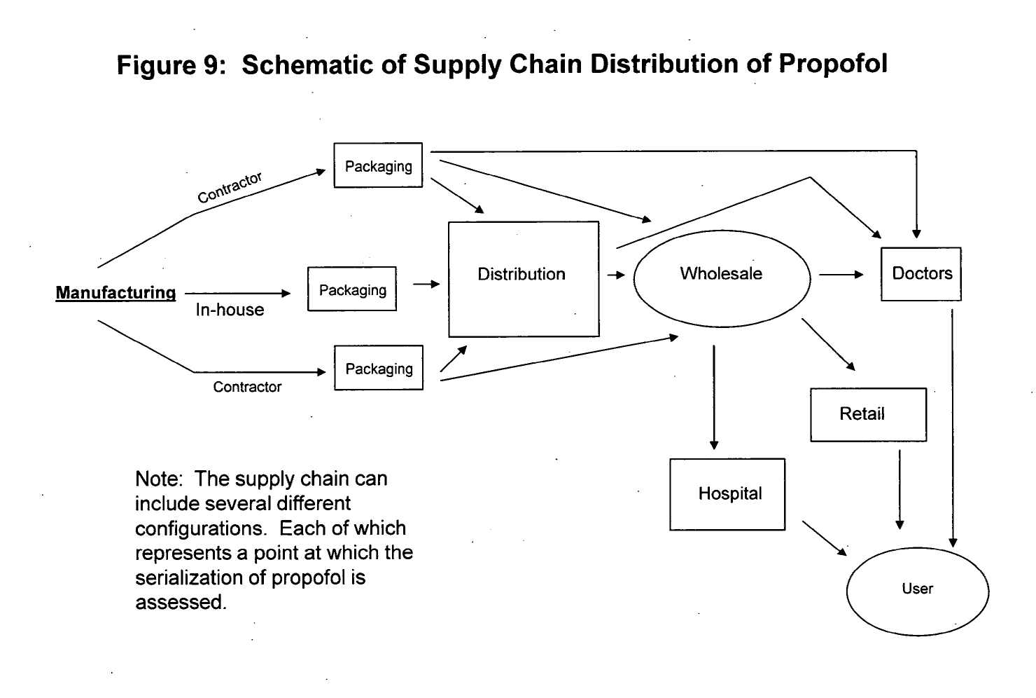

Proper supply chain management of packaged propofol is critical to provide quality propofol to end-users. This includes monitoring traditional areas of the supply chain including vial inspection, packaging, product protection, storage, and distribution. Specifically, from the point when the propofol product is packaged until it reaches the end-user (See, FIG. 9). In a preferred embodiment, the invention provides for a method of monitoring the manufacturing attributes of propofol by serialization of the propofol batches. This allows any entity in the propofol supply chain to properly track and trace each vial of propofol associated with a particular batch, lot, or control number. The serialization of the propofol of the present invention provides two advantageous purposes. First, it allows for easy tracking of quality attributes of a given batch, lot, or control number of propofol. Given the complex chemical properties associated with propofol, in the case of product recall, it would be easy to determine which vials need to be recalled. Second, it allows for easy tracking of propofol origin, which makes detecting counterfeit propofol easy to achieve. In a preferred embodiment, the serialization of the present invention comprises an e-pedigree.

VIII.) Background to Propofol Manufacturing

A. Raw Materials

The fountainhead of propofol manufacture begins with three (3) key ingredients. Phenol, propylene, and aluminum phenoxide. Additionally, solubilizing agents, surfactants, or oil-in-water emulsions and preservatives are added to produce propofol.

B. The Manufacturing Process

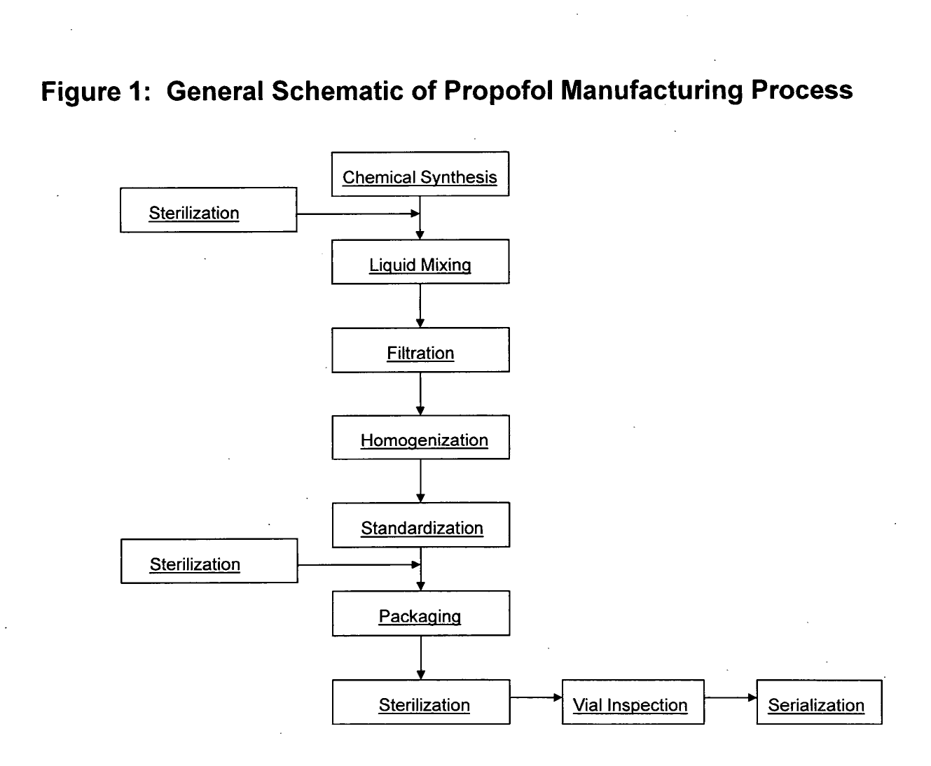

For a general schematic of the propofol manufacturing process, see FIG. 1. Although the manufacturing steps set forth in the figure look relatively simplistic, the manufacturing process to produce propofol is complex given that the properties of propofol and its route of administration to an end user make it necessary to produce propofol in a highly sterilized environment. This goal of a sterilized production, however, is hard to achieve. Reasons for this difficulty are many, but generally, the purity of raw materials and long chemical synthesis time make it possible for endotoxin to develop at an early stage of manufacture. This is especially true if the design of manufacture allows for testing product quality after the fact of production. For example, it is common for endotoxin levels to remain within an unacceptable level during production. If endotoxin levels are outside of an acceptable range at the beginning of production, this will affect endotoxin levels of propofol bulk and subsequent downstream processes. Additionally, other processes such as sterilization and pH must be continuously monitored to ensure that the purity and potency of the propofol is acceptable.

Given the deficiencies with current methods of manufacturing propofol, it is an object of the present invention to overcome these deficiencies with an integrated approach to manufacturing propofol. This integrated approach is achieved by the use of software and hardware devices and methods using said software and hardware devices whereby the entire propofol manufacturing process is monitored and whereby actual control of the propofol manufacturing process is achieved.

### EXAMPLES

Various aspects of the invention are further described and illustrated by way of the several examples that follow, none of which is intended to limit the scope of the invention.

### Example 1

### Utilizing the Manufacturing Execution System to Monitor a Chemical Synthesis Process for Propofol Manufacture

Generally speaking, chemical synthesis is purposeful execution of chemical reactions to get a product. For the purposes of the invention disclosed herein, the chemical synthesis to manufacture propofol is derived by a reaction of phenol with propylene in the presence of aluminum phenoxide which yields 2,6-diisopropylphenol (See, U.S. Pat. No. 3,476,838).

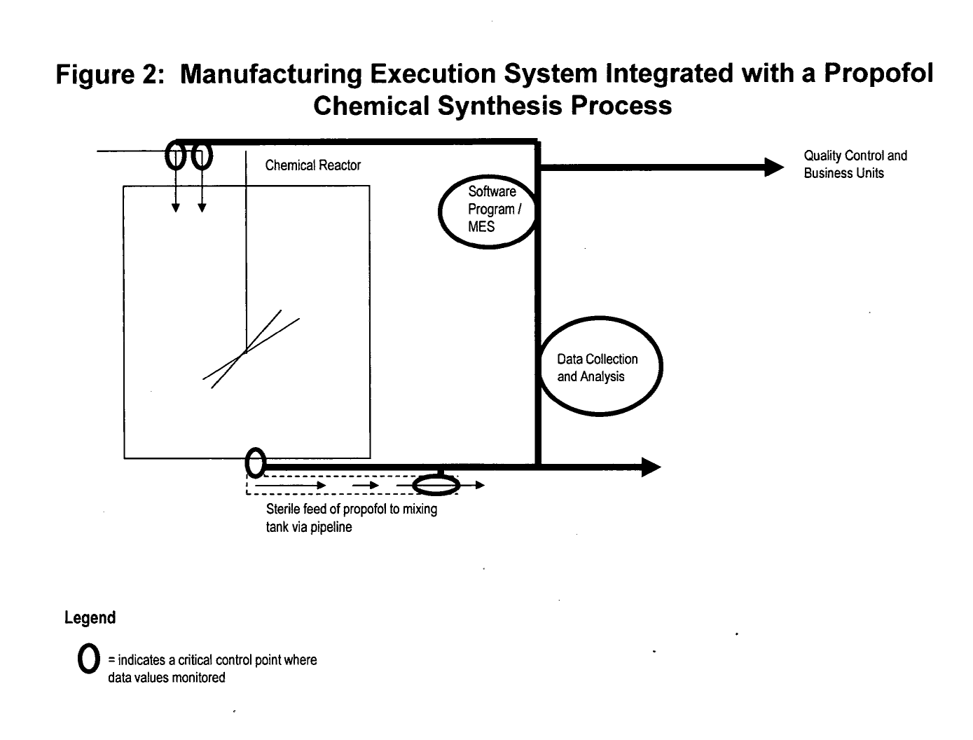

For purposes of this example, manufacturers begin with sterilized raw materials in a chemical reactor or other vessel known in the art (FIG. 2). The chemicals are synthesized using standard methods known in the art for the production of propofol to form an aqueous solution of propofol. The raw materials are mixed to predetermined properties and then shipped via pipeline to a sterile filtration systems. (FIG. 2).

In one embodiment, the Manufacturing execution system (“MES”) is integrated into the propofol chemical synthesis system used in propofol manufacture. In a preferred embodiment, the MES monitors pH, temperature, stirring velocity, raw material recipe parameters, solution concentration, endotoxin, particulate measurements (parts per million), and time using sensors of the invention. It will be understood by one of skill in the art that the MES integrates the hardware via generally understood devices in the art (i.e. attached to the analog device via an analog to digital converter). The MES is integrated into the propofol chemical synthesis system on a device-by-device basis. As previously set forth, the acceptance criteria of all devices used in the chemical synthesis system for the purposes of the propofol chemical synthesis processes are determined by the quality control unit. The analysis of the software and hardware occurs using any of the methods disclosed herein. The MES monitors and processes the data and stores the data using standard methods. The data is provided to an end user or a plurality of end users for assessing the quality of data generated by the device. Furthermore, the data is stored for comparative analysis to previous batches to provide a risk-based assessment in case of failure. Using the historical analysis will provide a more streamlined propofol chemical synthesis process and will monitor to ensure that the propofol chemical synthesis system(s) data is integrated into subsequent propofol manufacturing processes and systems.

In addition, the invention comprises monitoring the data from initial chemical synthesis processes, monitoring the data at the end of the chemical synthesis processes, and monitoring the data from a routine maintenance schedule to ensure the chemical synthesis system(s) maintain data integrity and validation standards predetermined by the quality control unit. (See, FIG. 2).

In one embodiment, the monitoring and analysis of the propofol chemical synthesis systems achieves a step of integration into a manufacturing execution system whereby propofol manufacturing productivity and product quality are increased. Costs are streamlined over time.

### Example 2

### Utilizing the Manufacturing Execution System to Monitor a Sterile Filtration Process for Propofol Manufacture

Generally speaking and for purposes of this example, sterile filtration is a mechanical sterilization process whereby a specialized filter is used to filter contaminants. In a preferred embodiment, the filter(s) used in this example have a pore size of 10 nm to 0.44 μm. In a further preferred embodiment, the filter has a pore size of 0.2 μm. Sterile filters of the invention are made of materials known in the art. However, in a preferred embodiment, the filters used in sterile filtration are made of polysulfone. In a further preferred embodiment, the filter is made of polyethersulfone (PES).

It is an object of the present invention to provide a novel method of producing propofol by utilizing a sterile filtration processes subsequent to the chemical synthesis of 2, 6 diisopropylphenol and prior to the liquid mixing step of propofol manufacture. The method provides several clear advantages over the prior art. First, the synthesized propofol is sterilized to prevent the growth and proliferation of endotoxin. Second, monitoring sterilization of the propofol prior to liquid mixing will ensure consistency of propofol manufacture over a plurality of batches. Finally, the costs of propofol manufacture will be streamlines over time.

By way of example, In the sterile filtration process, active propofol ingredient is directed via pipeline from the chemical synthesis tank or vessel into the filtration system. In a preferred embodiment, a pipeline is used to keep the synthesized propofol in a closed system to prevent the proliferation of endotoxin. The propofol is sent through the pipeline into the sterile filter at a temperature not exceeding 80 degrees C. and a pH of 6.0 to 8.0. The active propofol ingredient is then filtered and sterilized prior to the liquid mixing process.

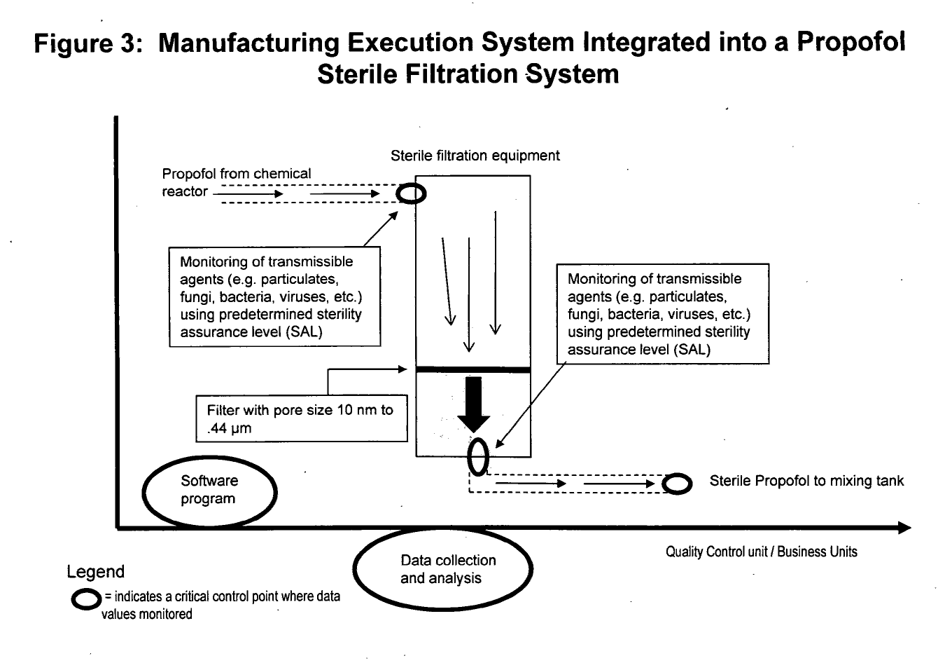

In one embodiment, the MES is integrated into a propofol sterile filtration system (FIG. 3) used in propofol manufacture. It will be understood by one of skill in the art that the MES integrates the hardware via generally understood devices in the art (i.e. attached to the analog device via an analog to digital converter). The MES is integrated into the sterile filtration system on a device-by-device basis. As previously described, the acceptance criteria of all devices used in the propofol manufacture for the purposes of sterile filtration are determined by the quality control unit. The analysis of the software and hardware occurs using any of the methods disclosed herein. The MES monitors and processes the data and stores the data using standard methods. The data is provided to an end user or a plurality of end users for assessing the quality of data generated by the device. Furthermore, the data is stored for comparative analysis to previous batches to provide a risk-based assessment in case of failure. Using the historical analysis will provide a more streamlined sterile filtration process and will ensure that the sterile filtration system data is integrated into chemical synthesis and liquid mixing systems and other systems used in propofol manufacture.

In addition, the invention comprises monitoring the sterile filtration data from initial process, monitoring the sterile filtration data at the end process, and monitoring the sterile filtration data from a routine maintenance schedule to ensure the system maintain data integrity and validation standard predetermined by the quality control unit. (See, FIG. 3).

In one embodiment, the monitoring and analysis of the sterile filtration systems achieves a step of integration into a manufacturing execution system whereby manufacturing productivity and propofol product quality are increased. Costs are streamlined over time.

### Example 3

### Utilizing the Manufacturing Execution System to Monitor the Liquid Mixing Process for Propofol Manufacture

Subsequent to the sterile filtration step, (See the Example entitled “Utilizing the Manufacturing Execution System to Monitor a Sterile Filtration Process for Propofol Manufacture.) the sterilized active propofol ingredients are then sent via pipeline to the liquid mixing tanks. As previously described, a pipeline provides a preferred embodiment due to the modality of keeping a closed process whereby endotoxin proliferation is minimized. The liquid mixing steps monitor a plurality of variables using the sensors of the present invention. For example, one variable is the addition of solubilizing agents, surfactants, or solvents (see, WO99/39696 Gensia Sicor). Additionally, preservatives to retard microbial growth are used. In one embodiment, the preservative is EDTA (See, U.S. Pat. No. 7,714,520 Zeneca Ltd.). Additionally, sulfites are used. Other excipients used to manipulate propertied of propofol are added as well (if needed). For example, sodium hydroxide is used to adjust pH and glycerol to make the formulation isotonic. One aspect of the invention is to produce the propofol product with a preservative. In another aspect of the invention, non-preserved propofol is produced. As distinguished from the prior art, utilizing the sterile filtration step of the invention, the proliferation of endotoxin is reduced and thus the need for the introduction of a preservative is significantly diminished, if not eliminated.

Another variable that is monitored in the liquid mixing system is the oil that creates the oil-in-water emulsion of the propofol of the invention.

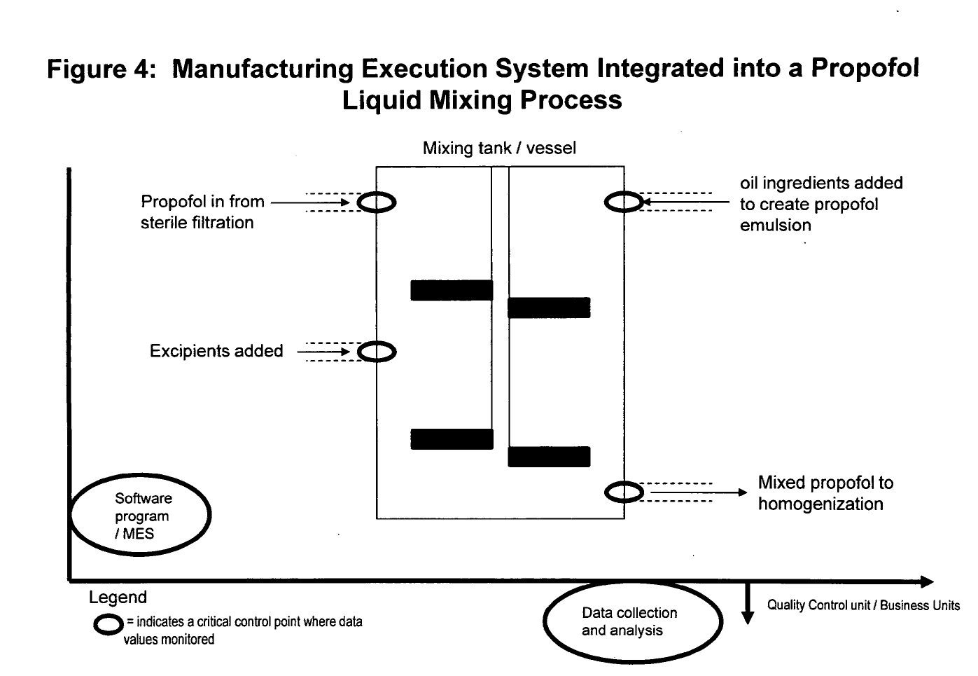

In one embodiment, the MES is integrated into a propofol liquid mixing system (FIG. 4) used in propofol manufacture. It will be understood by one of skill in the art that the MES integrates the hardware via generally understood devices in the art (i.e. attached to the analog device via an analog to digital converter). The MES is integrated into the liquid mixing system on a device-by-device basis. As previously described, the acceptance criteria of all devices used in the propofol manufacture for the purposes of liquid mixing are determined by the quality control unit. The analysis of the software and hardware occurs using any of the methods disclosed herein. The MES monitors and processes the data and stores the data using standard methods. The data is provided to an end user or a plurality of end users for assessing the quality of data generated by the device. Furthermore, the data is stored for comparative analysis to previous batches to provide a risk-based assessment in case of failure. Using the historical analysis will provide a more streamlined liquid mixing process and will ensure that the liquid mixing system data is integrated into sterile filtration and homogenization systems and other systems used in propofol manufacture.

In addition, the invention comprises monitoring the liquid mixing data from initial process, monitoring the liquid mixing data at the end process, and monitoring the liquid mixing data from a routine maintenance schedule to ensure the system maintain data integrity and validation standard predetermined by the quality control unit. (See, FIG. 4).

In one embodiment, the monitoring and analysis of the liquid mixing systems achieves a step of integration into a manufacturing execution system whereby manufacturing productivity and propofol product quality are increased. Costs are streamlined over time.

### Example 4

### Utilizing the Manufacturing Execution System to Monitor the Homogenization Process for Propofol Manufacture

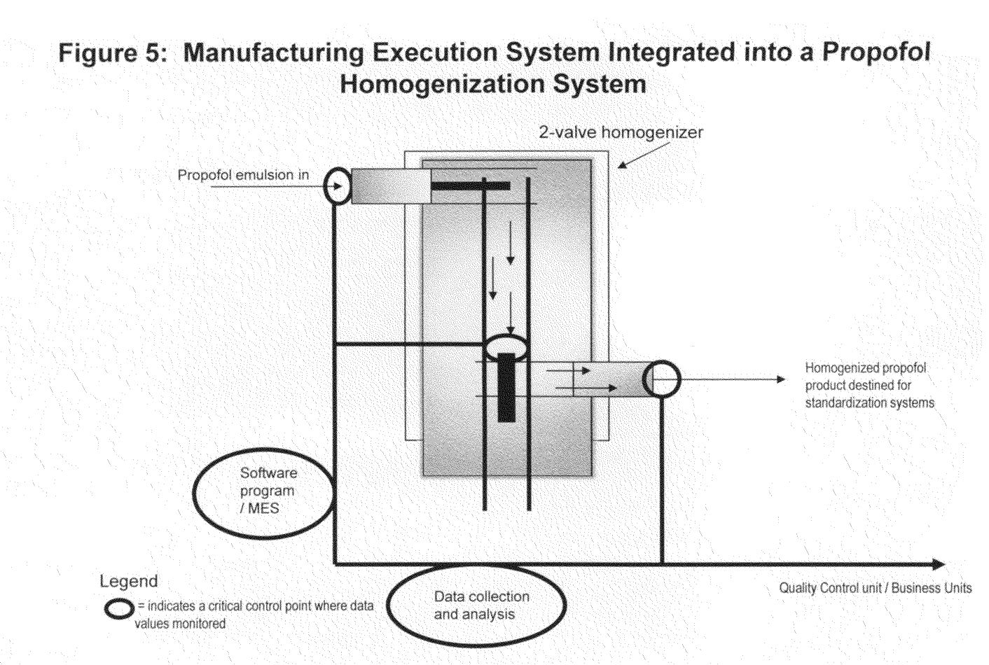

In the context of propofol manufacturing, homogenization is a term connoting a process that makes a mixture the same throughout the entire substance. In this case of the instant invention, the mixture is active propofol ingredient(s) in aqueous phase mixed with and oil phase to create an emulsion. For propofol this is necessary to increase emulsion uniformity and stability by reducing the size of the fat and oil particles in the propofol. To achieve this, modern homogenization technology is based on the use of pressure on liquids to subdivide particles or droplets present in fluids into the very smallest sizes (submicron) and create a stable dispersion ideal for further processing (i.e. propofol standardization, etc.). The passage of active propofol product at very high pressure through a specially designed valve with an adjustable gap, called a homogenizing valve, is able to microsize dispersed particles down to the order of magnitude of micrometers and nanometers. (FIG. 5). The fluid passes through a minute gap in the homogenizing valve. This creates conditions of high turbulence and shear, combined with compression, acceleration, pressure drop, and impact causing the disintegration of particles and dispersion throughout the propofol product. After homogenization, the particles are of a uniform size, typically from 100 to 245 nm, depending on the operating pressure. This is an important stage in the production of propofol products. It provides improved product stability and shelf life.

The current processes or methods of homogenizing of the instant invention can be broken down into three (3) major categories, ultrasonic, pressure, and mechanical. Ultrasonic homogenization is a widely used method to disrupt cells using ultrasonic disruption. These devices work by generating intense sonic pressure waves in a liquid media. The pressure waves cause streaming in the liquid and, under the right conditions, rapid formation of micro-bubbles that grow and coalesce until they reach their resonant size, vibrate violently, and eventually collapse. This phenomenon is called cavitation. The implosion of the vapor phase bubbles generates a shock wave with sufficient energy to break covalent bonds. Shear from the imploding cavitation bubbles as well as from eddying induced by the vibrating sonic transducer disrupt cells. There are several external variables which must be optimized to achieve efficient cell disruption. These variables are: tip amplitude and intensity, temperature, cell concentration, pressure, vessel capacity and shape.

Pressure homogenization is another widely used homogenization method. Generally, with the exception of highly filamentous microorganisms, this method has been found to be generally suitable for a variety of bacteria, yeast, and mycelia. This type of homogenizer works by forcing cell suspensions through a very narrow channel or orifice under pressure. Subsequently, and depending on the type of high-pressure homogenizer, they may or may not impinge at high velocity on a hard-impact ring or against another high-velocity stream of cells coming from the opposite direction. Machines which include the impingement design are more effective than those which do not. Disruption of the cell wall occurs by a combination of the large pressure drop, highly focused turbulent eddies, and strong shearing forces. The rate of cell disruption is proportional to approximately the third power of the turbulent velocity of the product flowing through the homogenizer channel, which in turn is directly proportional to the applied pressure. Thus, the higher the pressure, the higher the efficiency of disruption per pass through the machine. The operating parameters which affect the efficiency of high-pressure homogenizers are as follows: pressure, temperature, number of passes, valve and impingement design, and flow rate. An exemplary embodiment is set forth in FIG. 5.

Mechanical homogenization is the final type of homogenization method and can be broken down into two (2) subcategories. Rotor-stator homogenizers and blade type homogenizers. Rotor-stator homogenizers (also called colloid mills) generally outperform cutting blade-type blenders and are well suited for plant and animal tissue. Combined with glass beads, the rotor-stator homogenizer has been successfully used to disrupt microorganisms. However, the homogenized sample is contaminated with minute glass and stainless steel particles and the abrasive wear to the rotor-stator homogenizer is unacceptably high. This is why this homogenizing method is disadvantageous in propofol manufacture where endotoxin contamination must be minimized. Cell disruption with the rotor-stator homogenizer involves hydraulic and mechanical shear as well as cavitation.

Finally, blade type homogenizers are less efficient that rotor-stator homogenizers. In addition, many plant tissue homogenizers undergo enzymatic browning which is a biochemical oxidation process which can complicate subsequent separation procedures. For this reason, blade type homogenization is also disadvantageous in propofol manufacture.

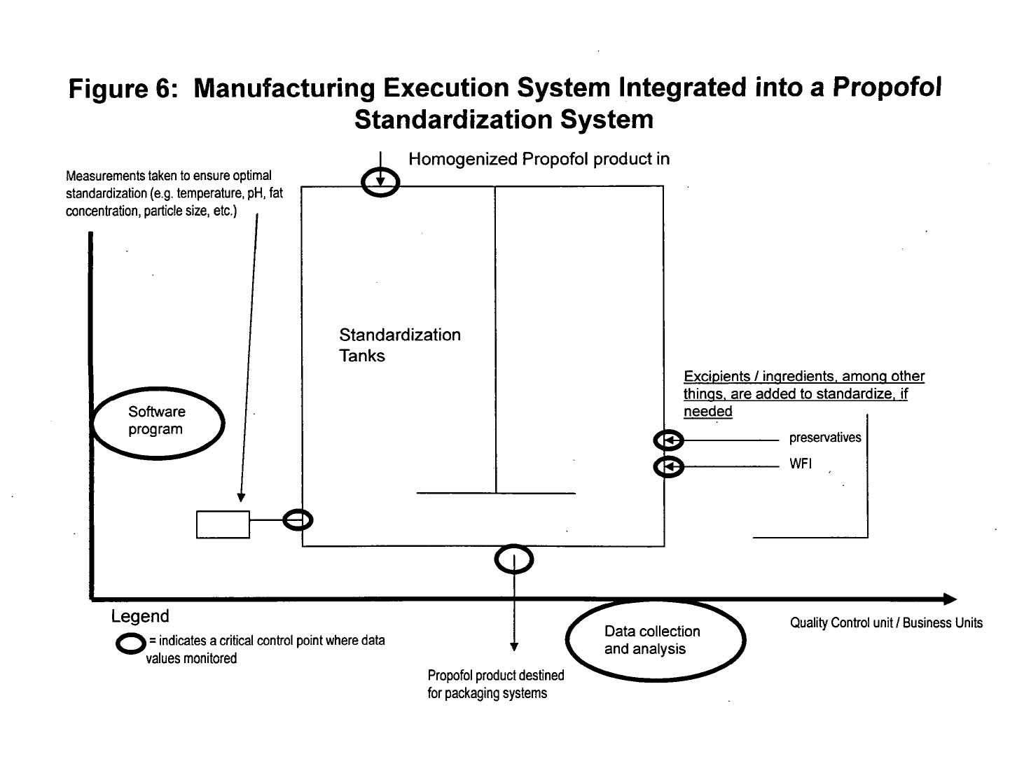

In one embodiment, the mixed emulsion of active propofol ingredient(s) (See, Example 3 entitled “Utilizing the Manufacturing execution system to monitor the liquid mixing process for propofol manufacture”) is ran through a homogenization system (See, FIG. 5). In a preferred embodiment, the homogenization system is a pressure homogenization system. The active propofol ingredient(s) are homogenized to the proper parameters and is sent to the standardization phase. Once the product is homogenized, it is stored using standard methods in a storage tank (FIG. 5 and FIG. 6).

In one embodiment, the MES is integrated into the homogenization system used in propofol manufacture. It will be understood by one of skill in the art that the MES integrates the hardware and sensors via generally understood devices in the art (i.e. attached to the analog device via an analog to digital converter). The MES is integrated into the homogenization system on a device-by-device basis. As previously, set forth, the acceptance criteria of all devices used in propofol manufacture for the purposes of the homogenization process are determined by the quality control unit. The analysis of the software and hardware occurs using any of the methods disclosed herein. The MES monitors and processes the data and stores the data using standard methods. The data is provided to an end user or a plurality of end users for assessing the quality of data generated by the device. Furthermore, the data is stored for comparative analysis to previous batches to provide a risk-based assessment in case of failure. Using the historical analysis will provide a more streamlined homogenization process and will monitor to ensure that the homogenization system data is integrated into the homogenization processes as well as other processes used to manufacture propofol. In addition, the invention comprises monitoring the data from initial process, monitoring the data at the end process, and monitoring the data from a routine maintenance schedule to ensure the system maintain data integrity and validation standard predetermined by the quality control unit. (See, FIG. 5).

In one embodiment, the monitoring and analysis of the propofol homogenization systems achieves a step of integration into a manufacturing execution system whereby propofol manufacturing productivity and product quality are increased. Costs are streamlined over time.

### Example 5

### Utilizing the Manufacturing Execution System to monitor a Standardization Process for Propofol Manufacture

Once the active propofol ingredient(s) have been homogenized, the next step is standardization. During the standardization step, the resulting propofol composition is standardized to ensure key parameters, such as pH, fat concentration, endotoxin, and preservative concentration (if required) are correct (generally against the previously set forth quality parameters provided by the quality control unit). If any of these ingredients are at insufficient levels (i.e. outside quality parameters) the propofol batch can be reworked to achieve the appropriate levels. The propofol batch is then ready to be packaged.

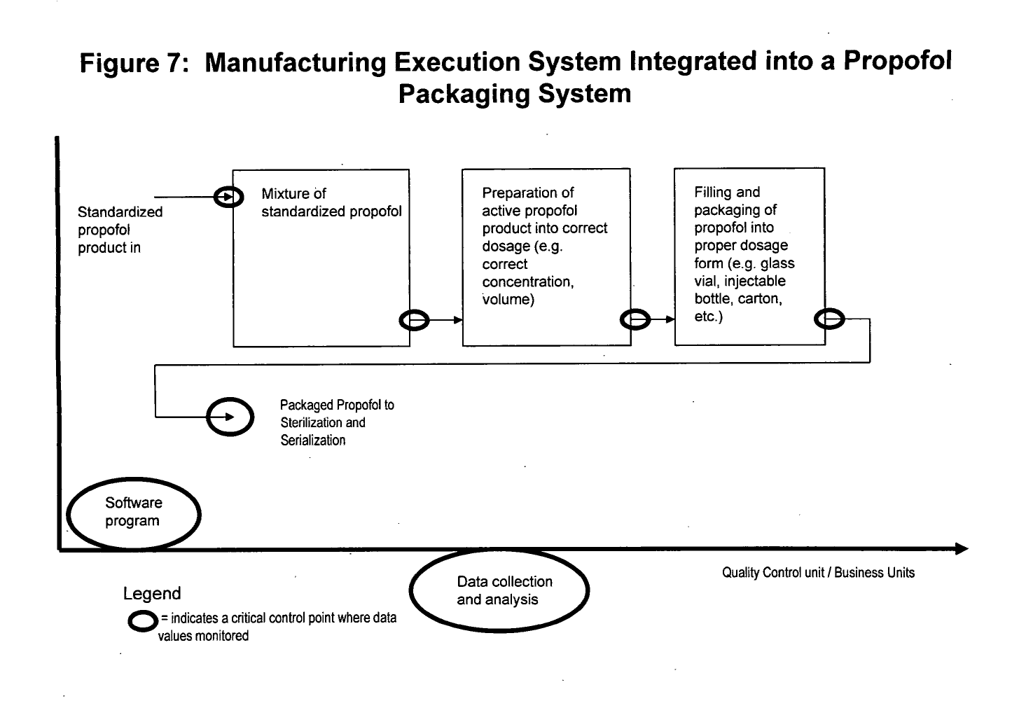

In one embodiment, the homogenized active propofol ingredient(s) (See, Example 4 entitled “Utilizing the Manufacturing execution system to monitor the Homogenization process for propofol manufacture”) is ran through a standardization system (See, FIG. 6). The active propofol ingredient(s) are standardized to the proper parameters and is sent to the packaging phase. Once the product is standardized, it is stored using standard methods in a storage tank (FIG. 6 and FIG. 7) preferably under sterile conditions.

In one embodiment, the MES is integrated into the standardization system used in propofol manufacture. It will be understood by one of skill in the art that the MES integrates the hardware and sensors of the invention via generally understood devices in the art (i.e. attached to the analog device via an analog to digital converter). The MES is integrated into the standardization system on a device-by-device basis. As previously, set forth, the acceptance criteria of all devices used in propofol manufacture for the purposes of the standardization process are determined by the quality control unit. The analysis of the software and hardware occurs using any of the methods disclosed herein. The MES monitors and processes the data and stores the data using standard methods. The data is provided to an end user or a plurality of end users for assessing the quality of data generated by the device. Furthermore, the data is stored for comparative analysis to previous batches to provide a risk-based assessment in case of failure. Using the historical analysis will provide a more streamlined propofol standardization process and will monitor to ensure that the standardization system data is integrated into the standardization processes and the entire propofol system at-large. In addition, the invention comprises monitoring the data from initial process, monitoring the data at the end process, and monitoring the data from a routine maintenance schedule to ensure the system maintain data integrity and validation standard predetermined by the quality control unit. (See, FIG. 6).

In one embodiment, the monitoring and analysis of the propofol standardization systems achieves a step of integration into a manufacturing execution system whereby propofol manufacturing productivity and product quality are increased. Costs are streamlined over time.

### Example 6

### Utilizing the Manufacturing Execution System to Monitor a Packaging Process for Propofol Manufacture

Packaging of active propofol ingredient(s) are important aspects of the propofol manufacturing process given that the finished propofol product is then ultimately distributed to the consumer. Currently, propofol products are administered via intravenous injection. Additionally, given the physical properties of propofol, sterile conditions are critical. Accordingly, the need for safe uniform packaging of propofol product is apparent to one of skill in the art.

In one embodiment, the standardized active propofol ingredient(s) (See, Example 5 entitled “Utilizing the Manufacturing Execution System to monitor a Standardization Process for propofol manufacture”) is sent to finishing and packaging and active propofol ingredient(s) are arranged into the proper dosage form and checked for uniform properties (See, FIG. 7). The active propofol ingredient(s) are filled into the proper dosage form. (FIG. 7). In a preferred embodiment, the dosage form of the invention is a vial.

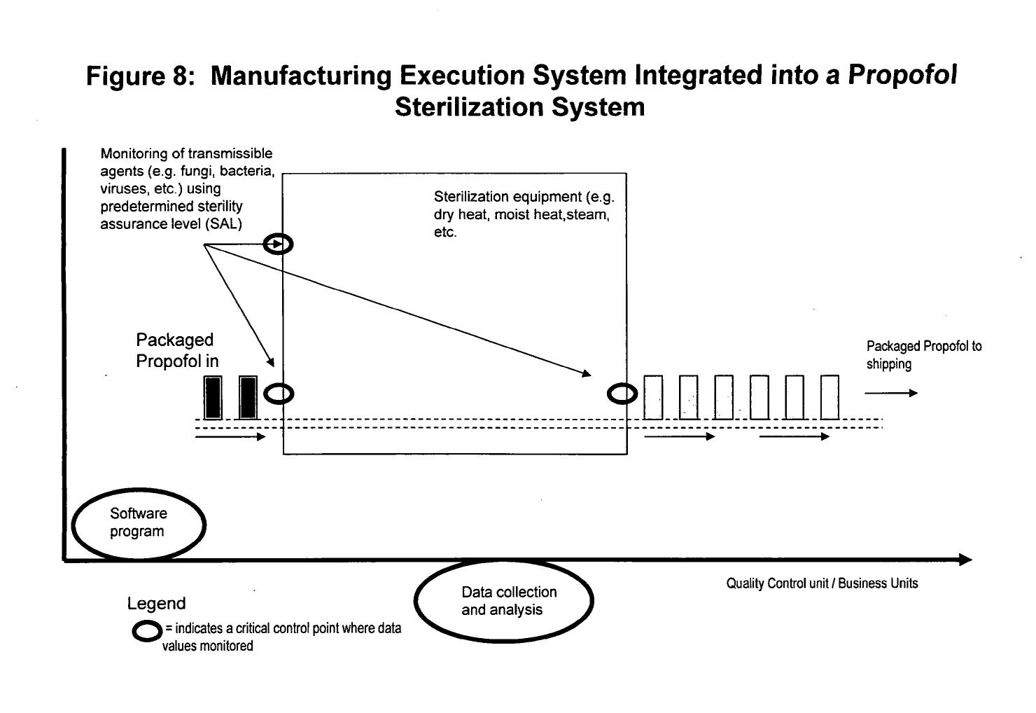

Once the propofol product is filled and sealed the package is inspected to ensure proper sealing prior to sterilization (FIG. 7 and FIG. 8) and then the packaged propofol product is sent to sterilization and is then stored using standard methods. (FIG. 8).

In one embodiment, the manufacturing execution system is integrated into the packaging system hardware. It will be understood by one of skill in the art that the manufacturing execution system integrates the hardware and sensors of the invention via generally understood devices in the art (i.e. attached to the analog device via an analog to digital converter).

The MES is integrated into the packaging system on a device-by-device basis. (FIG. 7). As previously set forth, the acceptance criteria of all devices used in the propofol product manufacture for the purposes of the packaging process are determined by the quality control unit. The analysis of the software and hardware occurs using any of the methods disclosed herein. The program monitors and processes the data and stores the data using standard methods. The data is provided to an end user or a plurality of end users for assessing the quality of data generated by the device. Furthermore, the data is stored for comparative analysis to previous propofol batches to provide a risk-based assessment in case of failure. Using the historical analysis will provide a more streamlined propofol packaging process and will monitor to ensure that ingredients are mixed and packaged properly. In addition, the invention comprises monitoring the data from initial process, monitoring the data at the end process, and monitoring the data from a routine maintenance schedule to ensure the system maintain data integrity and validation standard predetermined by the quality control unit.

In one embodiment, the monitoring and analysis of the propofol packaging systems achieves a step of integration into a manufacturing execution system whereby propofol manufacturing productivity and product quality are increased. Costs are streamlined over time.

### Example 7

### Utilizing the Manufacturing Execution System to Monitor a Sterilization Process for Propofol Manufacture

Generally, and for purposes of this example, ssterilization is a process that effectively kills or eliminates transmissible agents (such as fungi, bacteria, viruses, prions, and spore forms, etc.) from propofol product and propofol product packaging. Sterilization can be achieved through application of heat, chemicals, irradiation, high pressure or filtration. There are generally two types of sterilization, physical and chemical.

Physical sterilization includes heat sterilization and radiation sterilization. Chemical sterilization includes the addition of chemicals to facilitate the sterilization process. In propofol manufacture, heat sterilization is preferred since it is the least invasive and propofol is highly regulated and susceptible to endotoxin proliferation from a quality standpoint (the end user being of course, patients needing anesthetic).

Dry heat sterilization utilizes hot air that is either free from water vapor, or has very little of it, and where this moisture plays a minimal or no role in the process of sterilization. Generally, dry heat coagulates the proteins in any organism, causes oxidative free radical damage, causes drying of cells, effectively killing the microorganism. General methods of dry heat sterilization include but are not limited to the use of a hot air oven, flaming, radiation, or microwaves (See, FIG. 8).

Conversely, moist heat sterilization, as the name implies, utilizes hot air that is heavily laden with water vapor and where this moisture plays the most important role in the process of sterilization. Moist heat coagulates the proteins in any organism and this is aided by the water vapor that has a very high penetrating property, leading to their death. It also causes oxidative free radical damage. This can even, at high enough temperatures kill prions.

Sterility assurance level (SAL) is a term used in propofol manufacture to describe the probability of a single unit being non-sterile after it has been subjected to the sterilization process. For example, propofol manufacturers should design their sterilization processes for an extremely low SAL—“one in a million” propofol product units should be nonsterile. SAL is also used to describe the killing efficacy of a sterilization process, where a very effective sterilization process has a very high SAL.

In one embodiment, the packaged propofol product (See, Example 6 entitled “Utilizing the Manufacturing Execution System to monitor a Packaging Process for propofol manufacture ”) is sent to a sterilization process (See, FIG. 8) whereby the propofol product is then ready to be shipped to end users.

Once the propofol product is sterilized within pre-determined sterility assurance levels set forth by the quality control unit it is then stored using standard methods. (FIG. 8).

In one embodiment, the manufacturing execution system is integrated into the sterilization system hardware. It will be understood by one of skill in the art that the manufacturing execution system integrates the hardware and sensors of the invention via generally understood devices in the art (i.e. attached to the analog device via an analog to digital converter).

The MES is integrated into the sterilization system on a device-by-device basis. (FIG. 8). As previously set forth, the acceptance criteria of all devices used in the propofol product manufacture for the purposes of the sterilization process are determined by the quality control unit. The analysis of the software and hardware occurs using any of the methods disclosed herein. The program monitors and processes the data and stores the data using standard methods. The data is provided to an end user or a plurality of end users for assessing the quality of data generated by the device. Furthermore, the data is stored for comparative analysis to previous propofol batches to provide a risk-based assessment in case of failure. Using the historical analysis will provide a more streamlined propofol sterilization process and will monitor to ensure that ingredients are mixed and packaged properly. In addition, the invention comprises monitoring the data from initial process, monitoring the data at the end process, and monitoring the data from a routine maintenance schedule to ensure the system maintain data integrity and validation standard predetermined by the quality control unit.

In one embodiment, the monitoring and analysis of the sterilization systems achieves a step of integration into a manufacturing execution system whereby propofol manufacturing productivity and product quality are increased. Costs are streamlined over time.

### Example 8

### Utilizing the Manufacturing Execution System to Monitor Serialization and Supply Chain Management for Propofol Manufacture

Proper supply chain management of packaged propofol is critical to provide quality propofol to end-users. This is true, especially in light of the chemical properties of propofol and the route of administration to patients which make propofol susceptible to endotoxin proliferation during the course of manufacturing and supply chain distribution. One aspect of the present invention is to obviate these problems via integration with a manufacturing execution system of the invention and serialization of propofol products. This includes monitoring traditional areas of supply chain to include packaging, product protection, storage, and distribution. Specifically, from the point when the drug product is packaged (see, FIG. 7) until it reaches the end-user (See, FIG. 9). Depending on the geographic location of the end-user and circumstances surrounding the need for treatment, this could take weeks, months, etc.

In one embodiment, the packaged propofol product is serialized to include propofol product information including but not limited to, the name of the drug, the manufacturer of the drug, the location of manufacture, drug quantity, drug dosage form, drug strength, lot number, batch number, and control number, expiration date, recall information, and other detailed supply chain ownership information (bill of lading, import information, etc.).

In a preferred embodiment, the serialization process comprises a label that contains readable information which can be accessed through a variety of means known in the art.

In one embodiment, the label comprises RFID technology.

In one embodiment, the label comprises nanomaterials (including nanosensors of the invention).

In one embodiment, the label comprises barcodes.

In one embodiment, the label comprises time stamped audit trails.

In one embodiment, the label comprises electronic signatures.

In one embodiment, the label comprises global positioning systems (GPS) technology.

In a further preferred embodiment, the label containing propofol product serialization information comprises an e-pedigree.

In one embodiment, the invention provides for a propofol product whereby the propofol kit comprises a serialization label.

In one embodiment, the invention provides for a method of monitoring a propofol product whereby the propofol kit comprises a serialization label.

In a further embodiment, the invention provides for a method of monitoring a propofol product whereby the propofol kit comprises a serialization label and whereby the monitoring occurs from packaging to distribution (See, FIG. 9).

In a further embodiment, the invention provides for a method of monitoring a propofol product whereby the propofol kit comprises a serialization label and whereby the monitoring occurs from distribution to wholesale (See, FIG. 9).

In a further embodiment, the invention provides for a method of monitoring a propofol product whereby the propofol kit comprises a serialization label and whereby the monitoring occurs from wholesale to retail (See, FIG. 9).

In a further embodiment, the invention provides for a method of monitoring a propofol product whereby the propofol kit comprises a serialization label and whereby the monitoring occurs from retail to an end user (See, FIG. 9).

By way of non-limiting example, the propofol is manufactured using methods described herein and subsequently packaged and serialized (see, for example FIG. 7 and FIG. 8). The propofol package is serialized via a label as described herein. The label is read via standard methods known in the art. In a preferred embodiment, the label is read via wireless technology.

In one embodiment, the manufacturing execution system is integrated into the serialization system hardware. It will be understood by one of skill in the art that the manufacturing execution system integrates the hardware and sensors of the invention via generally understood devices in the art (i.e. attached to the analog device via an analog to digital converter).

The MES is integrated into the serialization system on a device-by-device basis. As previously set forth, the acceptance criteria of all devices used in the propofol product manufacture for the purposes of the serialization process are determined by the quality control unit. The analysis of the software and hardware occurs using any of the methods disclosed herein. The program monitors and processes the data and stores the data using standard methods. The data is provided to an end user or a plurality of end users for assessing the serialization data generated by the device. Furthermore, the data is stored for comparative analysis to previous propofol batches to provide a risk-based assessment in case of failure. Using the historical analysis will provide a more streamlined propofol serialization process and will monitor to ensure the propofol product is packaged and distributed properly. In addition, the invention comprises monitoring the serialization data from packaging to distribution. monitoring the serialization data from distribution to wholesale, monitoring the serialization data from wholesale to retail, and monitoring the data from retail to an end-user to ensure the propofol product attributes maintain data integrity. In a preferred embodiment, the serialization data comprises an e-pedigree.

In one embodiment, the monitoring and analysis of the serialization systems achieves a step of integration into a manufacturing execution system whereby propofol manufacturing attributes and product integrity are increased. Costs are streamlined over time.

### Example 9

### Utilization of Manufacturing Execution System in Commercial Propofol Manufacturing Processes

The invention comprises a method for monitoring the acceptance criteria of all components used in propofol manufacture. The analysis of the software and hardware occurs using any of the methods disclosed herein. The program monitors and processes the data and stores the data using methods known in the art. The data is provided to an end user or a plurality of end users for assessing the quality of the propofol batch. Furthermore, the data is stored for comparative analysis to previous propofol batches to provide a risk-based assessment in case of failure. Using the historical analysis will provide a more streamlined propofol manufacturing process and will provide cost-saving over time. In addition, the invention comprises monitoring the data from initial process, monitoring the data at the end process, and monitoring the data from a routine maintenance schedule to ensure the system maintain data integrity and validation standard predetermined by the quality control unit.

### Example 10

### Integration of the Manufacturing Execution System into a Propofol Manufacturing Device

The invention comprises the integration of the manufacturing execution system into a propofol manufacturing device. In this context, a device used in the propofol manufacturing process includes, but is not limited to, blenders, bioreactors, capping machines, chromatography/separation systems, chilled water/circulating, glycol, coldrooms, clean steam, clean-in-place (CIP), compressed air, D.I./R.O. watersystems, dry heat sterilizers/ovens, fermentation equipment/bioreactors, freezers, filling equipment, filtration/purification, HVAC, environmental controls, incubators, environmentally controlled chambers, labelers, lyophilizers, dryers, mixing tanks, modular cleanrooms, neutralization systems, plant steam and condensation systems, process tanks, pressure systems, vessels, refrigerators, separation/purification equipment, specialty gas systems, steam generators/pure steam systems, steam sterilizers, stopper washers, solvent recovery systems, tower water systems, waste inactivation systems, “kill” systems, vial inspection systems, vial washers, water for injection (WFI) systems, pure water systems, washers (glass, tank, carboys, etc.), centrifuges, user-independent audit trails, time-stamped audit trails, data security, confidentiality systems, limited authorized system access, electronic signatures, bar codes, dedicated systems, add-on systems, control files, Internet, LAN's, portable handheld devices, homogenizers, sterilizers, pasteurizers, etc.

It will be understood by one of skill in the art that the manufacturing execution system integrates the hardware via generally understood devices in the art (i.e. attached to the analog device via an analog to digital converter).

The manufacturing execution system is integrated into the propofol manufacturing system on a device-by-device basis. (FIG. 2-FIG. 9). As previously set forth, the acceptance criteria of all devices used in the propofol product manufacture for the purposes of the propofol manufacturing process are determined by the quality control unit. The analysis of the software and hardware occurs using any of the methods disclosed herein. The program monitors and processes the data and stores the data using standard methods. The data is provided to an end user or a plurality of end users for assessing the quality of data generated by the device. Furthermore, the data is stored for comparative analysis to previous propofol batches to provide a risk-based assessment in case of failure. Using the historical analysis will provide a more streamlined propofol manufacturing approach and will provide cost-saving over time. In addition, the invention comprises monitoring the data from initial process, monitoring the data at the end process, and monitoring the data from a routine maintenance schedule to ensure the system maintain data integrity and validation standard predetermined by the quality control unit.

### Example 11

### Integration of Manufacturing Execution System and Analysis Methods into a Comprehensive Cost-Saving System

The invention comprises a manufacturing execution system integrated into a comprehensive cost-saving propofol manufacturing system. A user, preferably a system administrator, logs onto the system via secure means (i.e. password or other security measures known in the art) and inputs the boundary values for a particular component of the propofol manufacturing process (i.e. upper and lower limits of pH, temperature, concentration, volume, mixing speed, SAL, homogenization pressure, packaging unit weight, etc.) The input is at the initial stage of propofol manufacture, the end product stage of propofol manufacture, or any predetermined interval in between that has been established for routine maintenance by the quality control unit. The data is generated using any one of the various analysis methods described herein (as previously stated the type of analysis used is functional to the device or protocol being monitored or evaluated). Subsequent to the data analysis, any modifications or corrective action to the propofol manufacturing process is implemented. The data is then stored by standard methods known in the art. Scheduled analysis of the stored data is maintained to provide a preventative maintenance of the propofol manufacturing process. Over time, costs are reduced due to the tracking of data and analysis of troubled areas and frequency of hazards that occur on any given device in the propofol manufacturing process. The system is implemented on every device which plays a role in propofol manufacturing. (FIG. 2-FIG. 9). The data compiled from every device is analyzed using the methods described herein.

### Example 12

### Integration of Method(s) and Program(s) into an Manufacturing Execution System (MES)

### Background:

A paradigm shift is needed in the way propofol is manufactured. Current processes are not readily understood by the industry at-large and the processes are time consuming and produce lower quality products. One of ordinary skill will appreciate that a lower quality propofol batch is essentially, a waste. Often the propofol batch must be run again using different production and system parameters. Quality control units that can continuously monitor a specific propofol manufacturing process and use that data, via data analysis methods disclosed herein, will allow propofol manufacturers to produce higher quality propofol products in a faster timeframe. The fountainhead goal is to build quality into a propofol product, rather than test for quality after the propofol product is made. This Quality by Design (QbD) approach will allow one of ordinary skill in the art to understand that the former method is advantageous since it will be easier to locate a defect in propofol manufacturing if monitoring is continuous rather than post-production or post-process. It is an object of the invention to provide this advantage.

### Integration:

In one embodiment, the software program is integrated into a manufacturing execution system that controls the propofol manufacturing process (generally set forth in FIG. 1 and specifically set forth in FIG. 10). It will be understood by one of skill in the art that the software program/computer product integrates the hardware and sensors of the invention via generally understood devices in the art (i.e. attached to the analog device via an analog to digital converter).

The software program/computer product is integrated into a manufacturing execution system on a device-by-device basis. (FIG. 2-FIG. 9). As previously set forth, the acceptance criteria of all devices used in propofol manufacture for the purposes of the manufacturing execution system are determined by the quality control unit. (FIG. 2-FIG. 9). The analysis of the software and hardware occurs using any of the methods disclosed herein. The program monitors and processes the data and stores the data using standard methods. The data is provided to an end user or a plurality of end users for assessing the quality of data generated by the device or devices. Furthermore, the data is stored for comparative analysis to previous propofol batches to provide a risk-based assessment in case of failure. Using the historical analysis will provide a more streamlined propofol manufacturing process and will monitor to ensure that propofol product quality is maximized. In addition, the invention comprises monitoring the data from initial process, monitoring the data at the end process, and monitoring the data from a routine maintenance schedule to ensure the system maintain data integrity and validation standards predetermined by the quality control unit.

The present invention is not to be limited in scope by the embodiments disclosed herein, which are intended as single illustrations of individual aspects of the invention, and any that are functionally equivalent are within the scope of the invention. Various modifications to the models, methods, and life cycle methodology of the invention, in addition to those described herein, will become apparent to those skilled in the art from the foregoing description and teachings, and are similarly intended to fall within the scope of the invention. Such modifications or other embodiments can be practiced without departing from the true scope and spirit of the invention.

1) A composition comprising,
a) a vial containing propofol; and
b) a label comprising computer readable information, whereby said computer readable information comprises propofol product serialization information.

2) The composition of claim 1, wherein the label comprises a nanomaterial.

3) The composition of claim 1, wherein the label comprises RFID technology.

4) The composition of claim 1, wherein the label comprises global positioning systems technology.

5) The composition of claim 1, wherein the label comprises a time-stamped audit trail.

6) The composition of claim 1, wherein the serialization information comprises a batch number.

7) The composition of claim 1, wherein the serialization information comprises a lot number.

8) The composition of claim 1, wherein the serialization information comprises a control number.

9) The composition of claim 1, wherein the serialization information comprises importation data.

10) The composition of claim 1, wherein the serialization information comprises an e-pedigree.

11) A method of monitoring propofol through a supply chain comprising,
a) labeling a packaged propofol product with serialization data during propofol manufacture;
b) reading the serialization data with a computer readable medium;
c) storing said serialization data to provide a supply chain record; and
d) assessing the supply chain record to confirm authenticity of said packaged propofol prior to use by an end-user.

12) The method of claim 11, wherein the supply chain comprises propofol distribution.

13) The method of claim 11, wherein the supply chain comprises propofol wholesale.

14) The method of claim 11, wherein the supply chain comprises propofol retail sale.

15) The method of claim 11, wherein the serialization data comprises a batch number.

16) The method of claim 11, wherein the serialization data comprises a lot number.

17) The method of claim 11, wherein the serialization data comprises a control number.

18) The method of claim 11, wherein the serialization data comprises manufacturer information.

19) The method of claim 11, wherein the serialization data comprises an expiration date.

20) The method of claim 11, wherein the serialization data comprises recall information.
